(19) United States
(12) Patent Application Publication
(10) Pub. No.: US 2007/0145030 A1
(43) Pub. Date: Jun. 28, 2007

(54) PLANAR HEATING DEVICE

(75) Inventor: Kuei Huang WU, Taipei Hsien (TW)

Correspondence Address: LEONG C LEI, PMB # 1008, 1867 YGNACIO VALLEY ROAD, WALNUT CREEK, CA, 94598, US

(73) Assignee: TOP-BOUND ENTERPRISE CO., LTD., Taipei Hsien (TW)

(21) Appl. No.: 11/467,935

(22) Filed: Aug. 29, 2006

(30) Foreign Application Priority Data
Dec. 15, 2005 (JP) JP2005-010624 U

(51) Int. Cl. H05B 3/00

(52) U.S. Cl. 219/211

(57) ABSTRACT

A planar heating device contains a two-dimensional, electrically and thermally conducting first member, a number of electrically and thermally conducting second member, and at least an insulating member. The second members are made of a conducting material having an impedance much lower than that of the first member. The second members and the first member are integrally molded or the second members are attached to a major surface of the first member by an appropriate mechanism. The electricity is introduced through the first member via the second members and, by the large contact areas between the first and second members, the electric current is evenly distributed and hot spots are avoided. The insulating members sandwich the other components inside to prevent short circuit or leakage.

### TECHNICAL FIELD OF THE INVENTION

The present invention generally relates to heating devices, and more particularly to a planar heating device where electricity is introduced via a number of low-impedance planar pieces.

### DESCRIPTION OF THE PRIOR ART

A conventional heating device usually uses a heating tube or wire as a linear heat source. To heat up a two-dimensional surface, these heating tubes or wires are usually arranged into a planar layout. However, the surface commonly suffers non-uniformed heat distribution and cannot be bended or folded.

The R.O.C. Taiwan Patent No. M257591 provides a two-dimensional heating device which is connected to conducting wires through contact points by riveting or welding. A hot spot is usually developed at the contact point and the high temperature would sometime set the packaging material on fire, presenting a serious threat to the user.

### SUMMARY OF THE INVENTION

The primary purpose of the present invention is to provide a planar heating device which generates uniform heating without any hot spot. Structurally, the heating device contains an electrically and thermally conducting first member, a number of electrically and thermally conducting second member, and two insulating members.

The first member can have any appropriate two-dimensional shape and is the main heat source under the conduction of electricity. The second members are made of a conducting material having an impedance much lower than that of the first member and have a large contact area with the first member. The second members and the first member are integrally molded or the second members are attached to a major surface of the first member by an appropriate mechanism. The electricity is introduced through the first member via the second members and, by the large contact areas between the first and second members, the electric current is evenly distributed and hot spots are avoided. The insulating member sandwiches the first and second members inside to prevent short circuit or leakage.

The second members can be formed into a braided piece, a meshed piece, or a linear strip. Multiple second members can be connected in series or in parallel so as to increase the contact areas with the first member even further.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a planar heating device according to an embodiment of the present invention.

FIG. 2 is a perspective exploded view showing the various components of the planar heating device of FIG. 1.

FIGS. 3a, 3b, and 3c are top views showing a number of embodiments of the arrangement of the second members.

FIGS. 4a, 4b, 4c, and 4d are top views showing a number of embodiments of the second member.

FIG. 5 is an application scenario of the present invention.

FIG. 6 is another application scenario of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

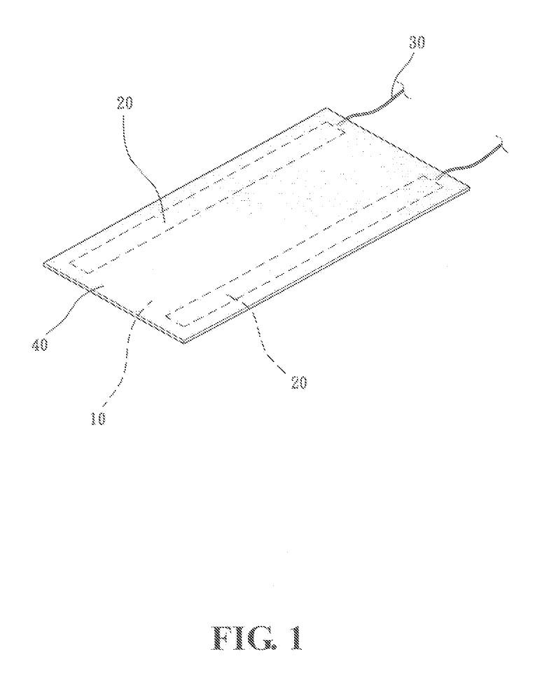

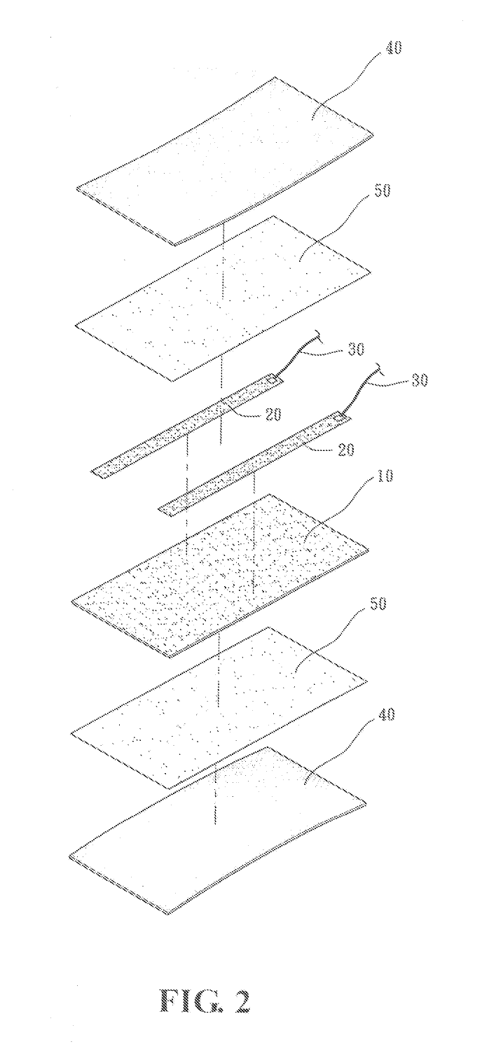

As illustrated in FIGS. 1 and 2, a planar heating device according to an embodiment of the present invention contains a two-dimensional, electrically and thermally conducting first member 10 having a first impedance, a number of electrically and thermally conducting second members 20 having a second impedance arranged on at least one of the two major surfaces of the first member 10, two conducting wires 30 connected to two second members 20 respectively, and two two-dimensional insulating members 40 for sandwiching the first and second members therebetween.

The first member 10 can be made of a flexible or rigid material that is electrically and thermally conducting. One typical example is rubber with embedded metallic or carbon powder. The first member 10 can have any appropriate two-dimensional shape. If the first member 10 is flexible, it can be adhered to the surface of any object. By configuring the first member 10 to achieve the appropriate first impedance, the first member 10 can provide uniform heating under the conduction of electricity.

The second members 20 can be made of a flexible or rigid material that is electrically and thermally conducting. The second impedance is quite low compared to the first impedance and is preferably below 1 ohm (usually, the first impedance is several times greater than the second impedance). The second members 20 can be shaped into slices or strips. If the second members 20 are flexible, they can be adhered to the surface of any object along with the first member 10. The first and second members 10 and 20 can be integrally molded together. For example, the material for the first member 10 is first pressed into an appropriate planar shape. The first member 10 and the second members 20 are then placed inside a mold and undergo a high-temperature and high-pressure process. The second members 20 are thereby embedded inside the first member 10. Another approach is to first molding the first member 10 into blocks and the blocks are then sliced into flat pieces. The second members 20 are later flatly attached to a major surface of the first member 10 by an appropriate mechanism. More details about the attachment mechanism will be given later.

The conducting wires 30 are connected to separate second members 20 respectively so that electric current is conducted through the planar heating device via a conducting wire 30 and the corresponding second member 20, the first member 10, another second member 20 and the other conducting wire 30.

The insulating members 40 are made of an electrically insulating material which can be a flexible or rigid one. The insulating members 40 securely seal the first and second members 10 and 20 inside so that the object to be heated will not directly contact the first and second members 10 and 20 to prevent short circuit or leakage.

The planar heating device can further contain two flat and adhesive members 50 immediately adjacent to the inner surfaces of the two insulating member 40 respectively so as to bond the foregoing components together.

According to the description above, a major characteristic of the present invention lies in the use of the low-impedance second members 20 to extend the conventional contact points into much larger contact areas. As such, the hazardous hot spots are avoided, electric current is more evenly distributed, and the first and second members 10 and 20 provide more uniform heating.

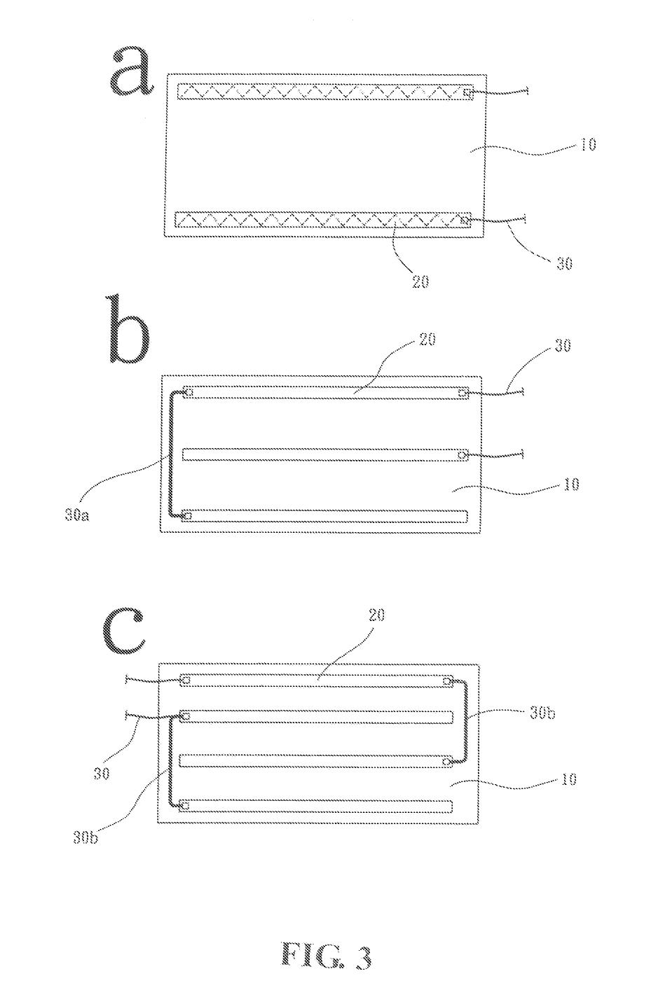

As shown in FIG. 3a, an embodiment of the present invention contains two second members 20 connected to two conducting wires 30 respectively. Please note that the second members 20 are stitched to a major surface of the first member 10.

As shown in FIGS. 3b and 3c, additional second members 20 can be used so as to achieve even more uniform distribution of electric current. As illustrated in FIG. 3b, a second member 20 is series-connected to another second member 20 by a conducting wire 30a. As illustrated in FIG. 3c, two second members 20 are paired to two other second members 20 by two conducting wires 30b respectively, with one pair in series connection and the other in parallel connection.

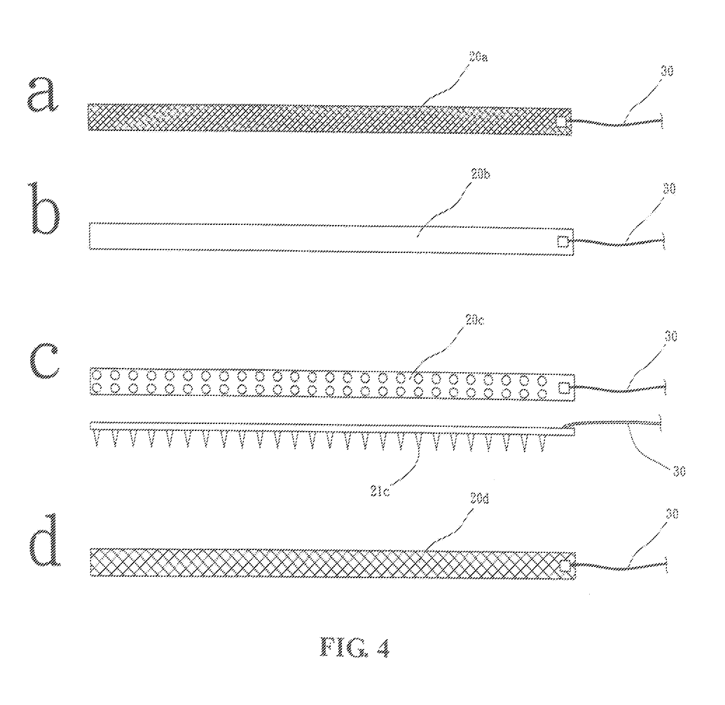

As shown in FIG. 4a, an embodiment of the second member 20a is a braided strip.

As shown in FIG. 4b, another embodiment of the second member 20b is a linear strip.

As shown in FIG. 4c, spikes 21c can be provided along a major surface of each second member 20c for piercing into the first member 10 for attachment.

As shown in FIG. 4d, yet another embodiment of the second member 20d is a meshed piece.

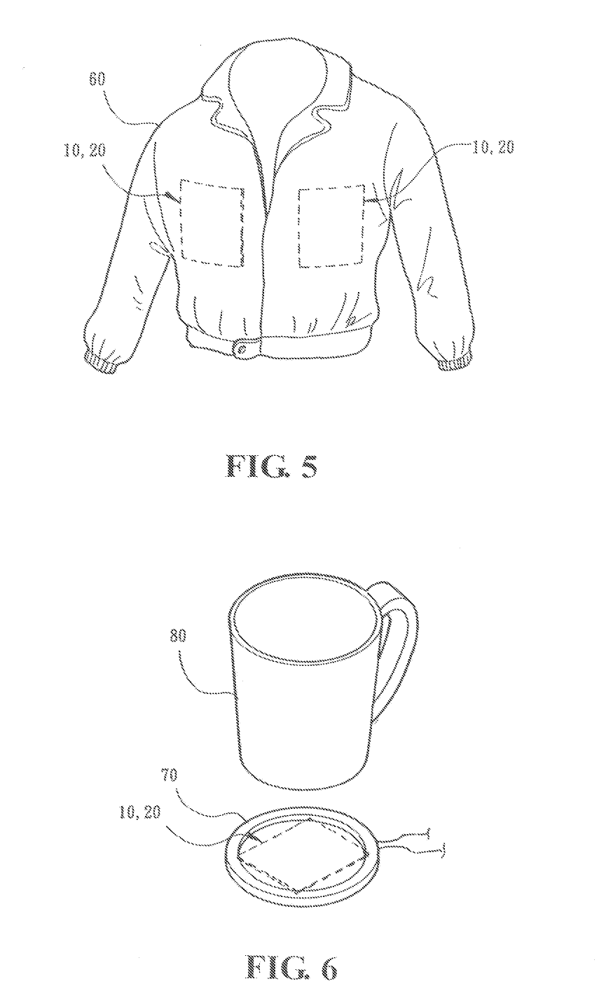

As illustrated in FIG. 5, the planar heating device can be buried inside a jacket or coat 60 to keep the wearer warm during cold weather.

As illustrated in FIG. 6, the planar heating device can be placed in a pad 70 so that the pad 70 functions like a hot plate to keep the drink in the cup 80 warm.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A planar heating device comprising:
an electrically and thermally conducting first member having a two-dimensional shape with a first impedance;
a plurality of electrically and thermally conducting second members having a second impedance lower than said first impedance, each said second member having a contact area with said first members; and
two conducting wires connected to two said second members respectively;
wherein heat is produced by introducing electricity through said first member via said conducting wires and said second members.

2. A planar heating device comprising:
a first member having a two-dimensional shape made of an electrically conducting rubber with a first impedance;
a plurality of electrically and thermally conducting second members having a second impedance lower than said first impedance, each said second member having contact area with said first member;
two conducting wires connected to two said second members respectively; and
two insulating members sandwiching said first and second members therebetween;
wherein heat is produced by introducing electricity through said first member to produce heat via said conducting wires and said second members.

3. The planar heating device according to claim 1, further comprising two adhesive members positioned adjacent to the two major surfaces of said first member so as to bond said first member and second members together.

4. The planar heating device according to claim 2, further comprising two adhesive members positioned between and immediately adjacent to said two insulating members respectively so as to bond said insulating members, first member, and second members together.

5. The planar heating device according to claim 1, wherein said second members are attached to a major surface of said first member.

6. The planar heating device according to claim 2, wherein said second members are attached to a major surface of said first member.

7. The planar heating device according to claim 1, wherein said second members are embedded inside said first member.

8. The planar heating device according to claim 2, wherein said second members are embedded inside said first member.

9. The planar heating device according to claim 1, wherein a said second member is formed into one of a braided piece, a meshed piece, and a linear strip.

10. The planar heating device according to claim 2, wherein a said second member is formed into one of a braided piece, a meshed piece, and a linear strip.
